(19) United States
(12) Patent Application Publication
(10) Pub. No.: US 2006/0161503 A1
(43) Pub. Date: Jul. 20, 2006

(54) Budget browsing method, system, apparatus, and software product

(76) Inventors: Andrei Popescu, Helsinki (FI); Salla Myllyla, Helsinki (FI); Virpi Roto, Espoo (FI); Roland Geisler, Burlington, MA (US); Antti Koivisto, Helsinki (FI); Guido Grassel, Espoo (FI); Mikko Makela, Tampere (FI); Adam Berger, Pittsburgh, PA (US)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 11/039,385

(22) Filed: Jan. 18, 2005

(51) Int. Cl. G06F 17/00

(52) U.S. Cl. 705/400

(57) ABSTRACT

A method, apparatus, system, and software product are presented for allowing a user to control web browsing costs incurred when using a device such as a mobile device to access the world-wide web. The invention involves selecting a preferred browser strategy from a plurality of browser strategies that correspond to respective levels of estimated browsing costs, and then browsing at least one web page using the preferred browser strategy.

### FIELD OF THE INVENTION

The present invention relates to web browsing in systems where the user pays for the amount of transferred data.

### BACKGROUND OF THE INVENTION

Most internet connection providers do not offer flat rates for data services, but instead charge their users depending on the volume of data that they transfer. This leads to the problem that many internet users are reluctant to access the web (i.e. the Internet, also known as the world wide web or www).

For example, mobile phone users are reluctant to access the web because they are afraid of the high costs that web browsing might involve. Studies have clearly indicated that one of the major preoccupations for mobile phone users is developing techniques for browsing the internet in a way that minimizes their connection costs. Incidentally, the terms “mobile phone user,” “mobile user,” “mobile device user,” and “user” all broadly refer in this application to a user of any mobile device capable of accessing the internet, and the term “user” also refers to other internet users.

An average user does not have any idea what precisely causes browsing costs. The average user does not even know whether the user is charged by the time that the connection is open, as compared to the amount of data transferred during the session. Therefore, many users attempt to minimize both time and data transfer in the hopes of reducing the browsing costs. Providing users with a set of on/off settings for images, flash, applets and the like does not significantly help these users to control the costs, and a better approach is needed.

It would be a major benefit for the users if a browser provided a set of built-in browsing strategies that would let the users control their browsing costs easily, without any substantial technical knowledge about those browsing costs. One of the problems in this kind of a system is that internet connection providers and operators are generally very reluctant to let users control the browsing costs. Were the connection providers not so reluctant, then it would be possible to build a much better system in which, for example, a progress indicator displays to the user the money spent, while the page is loading. Unfortunately, experience with voice calls shows that telecommunications companies are unlikely to help users achieve cost control, and thus it will almost certainly be impossible to provide the mobile users around the world a reliable cost control system for web browsing. It is therefore apparent that there is a need for a system that only relies on the amount of data downloaded, and that does not require substantial cooperation of connection providers.

Current browsers, such as OPERA and others, do not directly provide a set of such cost control strategies. Instead, they provide settings that are not displayed to the average user as being directly related to the cost of browsing. Such settings usually consist simply of a toggle button for setting the loading of images and/or animations on or off. Some browsers, like NETSCAPE and MOZILLA, allow blocking of pictures and pop-up windows, but again there is little of direct significance to the cost of browsing.

Standard internet communication methods have thus far not been utilized to reduce a user's browsing costs. For example, standard internet communication methods can allow users to find out the size of an entity that would have been sent to the user if the user had requested that entity (see Hypertext Transfer Protocol—Http/1.1 dated June 1999 which is incorporated herein by reference). It would be useful to somehow harness these and other techniques, in order to help users to better afford the experience of web browsing subject to a charge (i.e. in cases where the user lacks unlimited access at a flat rate).

### SUMMARY OF THE INVENTION

The invention consists of a concept that defines a number of browser strategies for dealing with web content. Every strategy is explicitly related to a corresponding level of browsing costs. The selectable strategies are presented to the users with a simple control in the browser user interface (UI). The user decides which strategy to choose depending on the user's financial constraints.

Examples of selectable strategies are as follows. First, luxury browsing implies maximum costs, and in this strategy the browser displays the entire content of the web pages. Second, intermediate browsing implies somewhat reduced costs, and in this strategy the browser uses a heuristic method to eliminate certain types of content (e.g. advertising, very large images, flash animations, and the like). In addition, intermediate browsing may use operator server-side support, if available, for retrieving downscaled versions of the document images. Third, economy browsing implies the lowest possible cost, and in this strategy only the plain text of the document is shown. Images are shown only if they exist in the cache, when economy browsing is selected.

The method of the present invention is for controlling web browsing costs incurred when accessing the world-wide web via a connection subject to charge. This is accomplished by selecting a preferred browser strategy from a variety of browser strategies that correspond to respective levels of estimated browsing costs. Then, the device browses one or more web pages using that preferred browser strategy.

The computer readable medium of the present invention is encoded with a software data structure for controlling web browsing costs that are incurred when accessing the world-wide web via a connection subject to additional charges. The software initiates a preferred (i.e. selected) browser strategy that is one of a plurality of selectable browser strategies which correspond to respective levels of estimated browsing costs. The software then allows the user to browse one or more web pages using that preferred browser strategy.

Similarly, the device of the present invention is for controlling web browsing costs incurred by using the device to access the world-wide web. The device includes a user interface for allowing a user to select a preferred browser strategy from a variety of browser strategies that correspond to respective levels of estimated browsing costs. The user interface is also for providing a preferred browser strategy signal. Also included in the device is a browsing control module, which is responsive to the preferred browser strategy signal from the user interface, and which ensures that the device browses one or more web pages using the preferred browser strategy.

Likewise, the system of the present invention is for controlling web browsing costs incurred when accessing the world-wide web via a connection subject to charge (i.e. as distinguished from free or flat-rate access to the web). The system includes a device that allows a user to select a preferred browser strategy from among a variety of browser strategies that correspond to respective levels of estimated browsing costs. The device is also for allowing the user to select one or more web page to browse using the preferred browser strategy.

### BRIEF DESCRIPTION OF THE DRAWINGS

FIG. 1 is a flow chart showing an embodiment of the invention in which a default strategy for affordable web browsing is shown, with exceptions to the default.

FIG. 2 is a flow chart showing an embodiment of the invention in which a web page component is downloaded only if it seems affordable to a mobile device.

FIG. 3 is a flow chart showing an embodiment of the invention in which a web server only provides content if it seems affordable to the web server.

FIG. 4 is a flow chart showing an embodiment of the invention in which a browser strategy provides different settings when different bearer are used to deliver content.

FIG. 5 depicts a mobile device according to the present invention.

FIG. 6 depicts a system according to the present invention, in which the network side tries to accommodate a user's browser strategy.

FIG. 7 illustrates a system according to the present invention, in which a mobile device tries to pick out affordable web page components.

### DETAILED DESCRIPTION OF THE INVENTION

According to an embodiment of the present invention, different browsing strategies are used to minimize browsing-related costs, especially when using a mobile terminal within reach of different bearers such as General Packet Radio Service (GPRS), Wireless Local Area Network (WLAN), Bluetooth (BT), or the like. Although the present invention is applicable to a personal computer having a wired connection, the embodiment described below is a wireless embodiment, for purposes of illustrating how the invention works. Based upon the user-selected browsing strategy, a device is able to interact with bearers and content providers so as to maximize the browsing experience while minimizing the costs to the user.

In addition to luxury, intermediate, and economy browsing strategies, custom browsing is an additional selectable strategy, and in this strategy the user has the possibility to specify a cost threshold for an entire browsing session, for each document, or even for each image. According to this custom browsing strategy, the browser reacts by displaying a warning if the threshold is reached, or the browser can inform the user the estimated cost of downloading a certain web page or image and ask the user whether it should proceed or not.

In addition, the browser of the present invention can optionally remember and re-apply the chosen strategy in the context of each document. This implies a mechanism for storing the user-preferred strategy for each visited URL. It therefore becomes possible, for example, to browse automatically in economy mode the large web front-page of a newspaper and jump into luxury mode as a result of the user following a link that leads to a certain article. If the user subsequently navigates to a sports result web page, the browser will automatically enter the intermediate mode, filtering out most of the cluttering advertising and displaying only the “useful images” that indicate whether a certain game is undergoing or finished, and the like. The selectable browsing strategies of the present invention can be stored as a set of rules, expressed in a form that can be easily parsed and interpreted by a computer program (e.g. using XML). Generally speaking, the browser system of the present invention can load only those images that belong to that part of the web page that has been identified as the likely most important part of the page, i.e. the “main content” in that web page.

Page components can be analyzed in order to either estimate their cost, or determine if they are covered by a particular browsing strategy, or both. This analysis can be done by requesting from the web server the size or weight of the content, before retrieving it, for example by issuing an HTTP HEAD request and deriving the size from the content-length field of the response header (see Hypertext Transfer Protocol—Http/1.1 dated June 1999 which is incorporated herein by reference). The response-header fields allow the server to pass additional information about the response which cannot be placed in the status-line. These header fields give information about the server and about further access to the resource. The content-length indicates the size of the entity-body, in decimal number of octets, sent to the recipient or, in the case of the HEAD method, the size of the entity-body that would have been sent had the request been a GET.

The mechanism for storing the user-preferred strategy for each visited page could be implemented into an auto bookmarks system, which records the most frequently viewed pages from the history. The implementation into auto bookmarks is done by adding a unique identifier of the browsing strategy to be applied for each coded URL. A similar approach is feasible for regular user-initiated bookmarks as well.

The major advantage of providing a set of browsing strategies defined in terms of costs is that users will get highly improved control over how much they will spend for browsing. For instance, when they select the “economy” browsing strategy, they will no longer worry whether there is anything else they could do to reduce the costs even more, except by cutting the amount of browsing. Defining a custom browsing strategy will no longer mean tweaking more or less obscure technical settings, but defining a set of preferences that have clear meanings in terms of expense to the user.

The present invention can be implemented with server-side support. After a user configures the mobile browser in one of the modes (economy, full, intermediate, et cetera), the browser transmits this mode preference as part of the HTTP headers it sends to every web server, whenever it issues an HTTP GET request to the server. Web servers can thus be made aware of this new HTTP header and can adapt the web content according to the cost-preferences of the user, before transmitting the content to the device.

For a device used by multiple users, it is feasible to maintain separate browsing strategy settings (e.g. economy, full, intermediate, or custom) for each of the multiple users. Even if a device is used by a single user, separate browsing strategy settings can be used for different bearers, such as different wireless providers or different types of wireless networks. For example, when the user accesses a particular URL, the device can use intermediate mode unless the user is roaming outside the coverage of the user's service provider, in which case economy mode would be preferred for that URL.

When browsing with a mobile device and moving from one type of a network to another, it is likewise possible to predict or estimate which mode is the best one for each bearer, by sensing continuously the highest permissible data rate of the user; the lower the permissible data rate, then a higher cost is assumed, and thus a lower-cost browsing strategy is used. Alternatively, a static default can be used for each bearer, although it would be preferable to use continuous sensing. The device (e.g. phone) should also be able to make assumptions about the cost of each bearer; a wireless local area network is generally free and therefore luxury browsing would be appropriate, whereas other bearers would not be free, especially if the user is roaming beyond the area serviced by the user's service provider.

Let us now consider the figures. Various embodiments of the present invention are illustrated therein, to help more fully explain the inventive concept and how it can be put into practice.

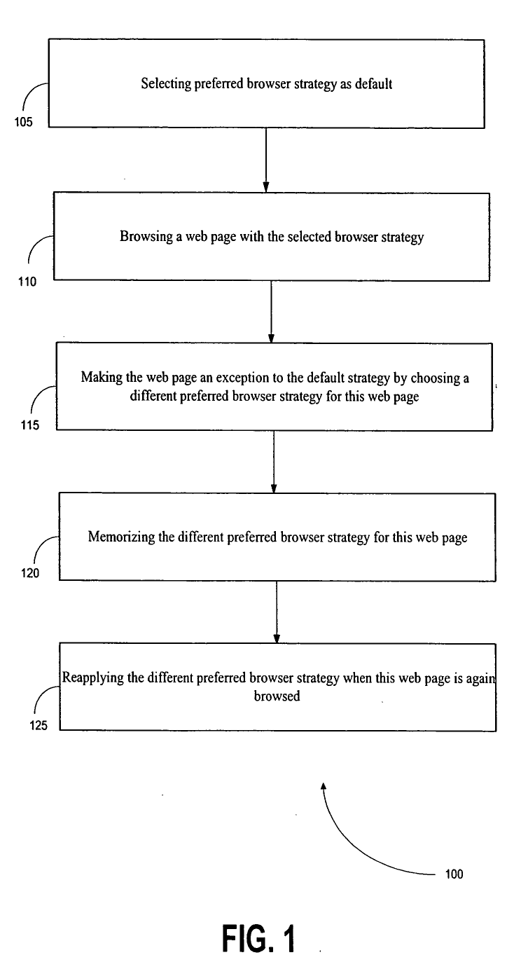

FIG. 1 shows a method 100 that begins by selecting 105 a preferred browser strategy as a default strategy (e.g. an intermediate cost strategy). Then a web page is browsed 110 using that default strategy. However, the user may decide to make 115 an exception for that particular web page, and thus choose a different preferred browser strategy (e.g. luxury) as an exception to the default. That exception is then memorized 120 so that it can be reapplied 125 in the future.

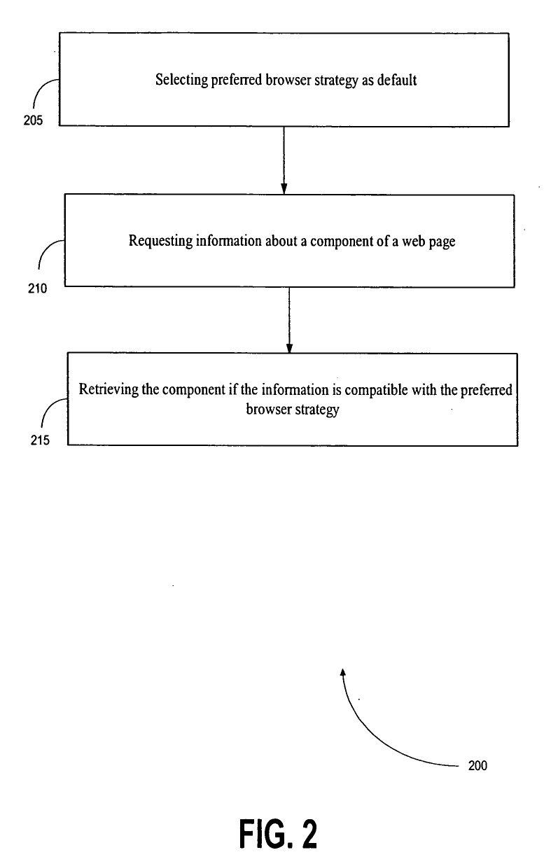

FIG. 2 shows a method 200 that begins by selecting 205 a preferred browser strategy as a default strategy, and then requesting 210 information about a component of a web page, for example from a web server. Then that component is retrieved 215 if it is compatible with the preferred browser strategy selected in step 205. Otherwise, the component is not retrieved, and the web page is presented to the user without that component.

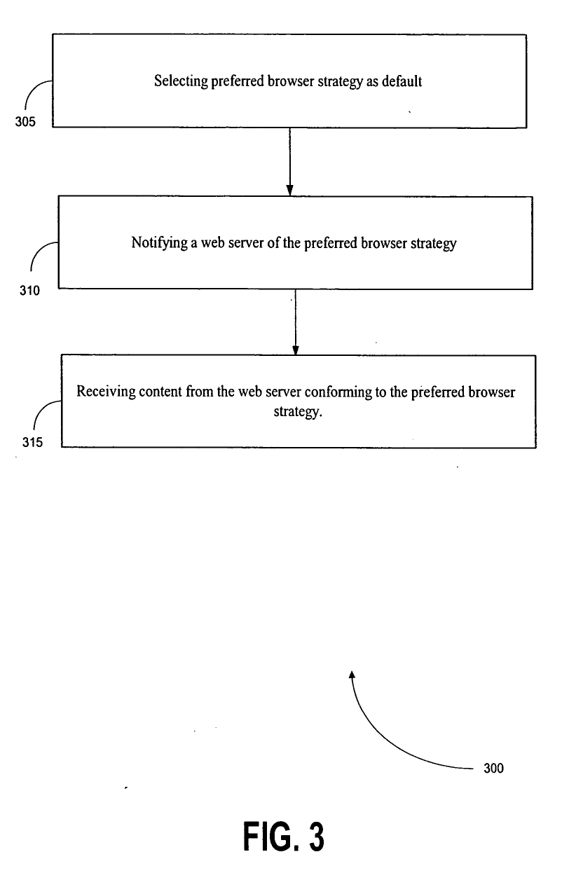

FIG. 3 shows a method 300 that begins by selecting 305 a preferred browser strategy as a default strategy, and then a web server is notified 310 of the preferred browser strategy. The mobile device then receives 315 content from the web server conforming to the preferred browser strategy. In contrast to FIG. 2, the method of FIG. 3 has the web server determining compatibility of content rather than the mobile device determining compatibility.

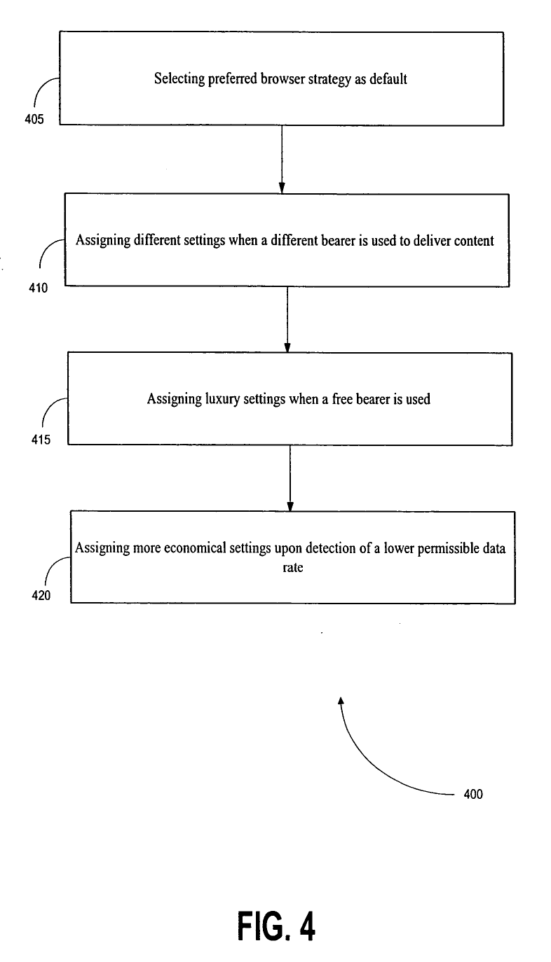

FIG. 4 illustrates a method 400 that once again begins by selecting 405 a preferred browser strategy as a default strategy. Then different settings are assigned 410 when a different bearer is used. If eventually a free bearer is used 415 then luxury setting are used, so that the entire content of a web page is loaded. A device can also be equipped to detect whether the user is restricted from having a data rate above a permissible data rate (i.e. above a threshold), and the lower the threshold then the more spartan the browsing should be. Thus, more economical settings are assigned 420 upon detection of a lower permissible data rate.

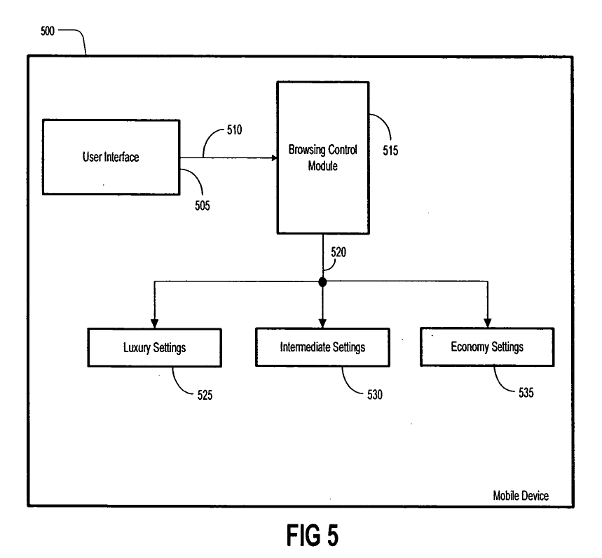

FIG. 5 shows a mobile device 500 according to the present invention. As mentioned above, the present invention is applicable to a personal computer having a wired connection, but the embodiment described here and in the figures is a wireless embodiment for purposes of illustrating how the invention works.

A user interface 505 provides a preferred browser strategy signal 510 to a browsing control module 515 (this module may of course be a component of software as opposed to hardware). The browsing control module 515 subsequently provides setting activation and deactivation signals 520 to one or more of the luxury settings 525, intermediate settings 530, and economy settings 535 in order to ensure that the preferred browsing strategy is carried out as the user moves from one bearer to another.

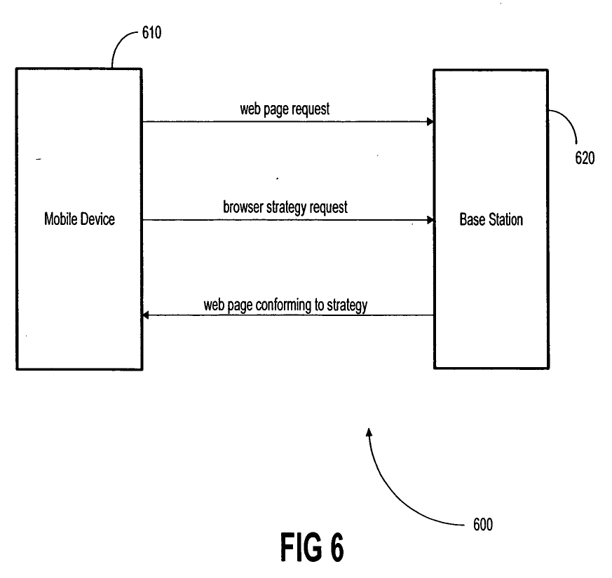

FIG. 6 shows a system 600 according to the present invention, including a mobile device 610 and a base station 620. The mobile device provides the base station with a web page request, and also informs the base station about the user's browser strategy. After contacting the internet via the telecommunications network, the base station 620 provides the mobile device 610 with the web page in such a way as to conform to the browser strategy of the user. A person skilled in the art will easily understand how this sort of arrangement is applicable in a non-wireless setting.

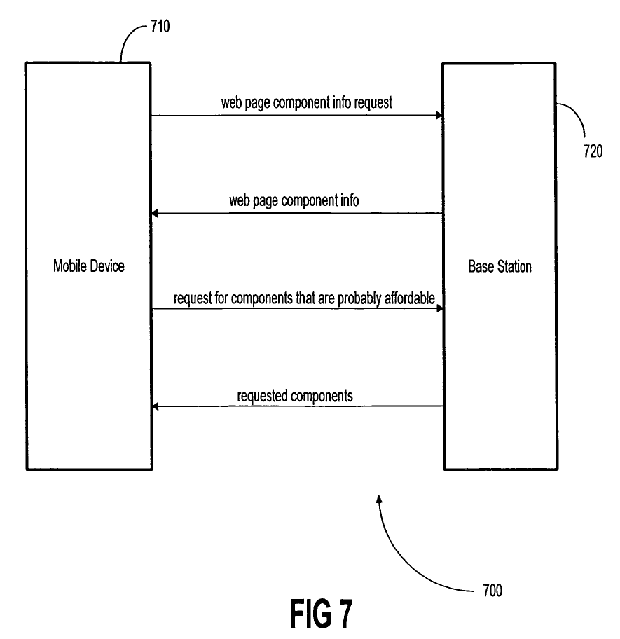

FIG. 7 shows another system 700 according to the present invention, in which a mobile device 710 interacts with a base station 720. The mobile device asks the base station for information about a component of a web page that is being browsed, and the base station obtains and provides that information to the mobile device. The mobile device 710 analyzes this component information, which may indicate the size of the component and thus may suggest the probable price of downloading the component. So, the mobile device will then request only those components that it determines are probably affordable, in accordance with the browsing strategy. Finally, the requested components are downloaded. Again, a person skilled in the art will easily understand how this sort of arrangement is applicable in a non-wireless setting.

It is to be understood that all of the present figures, and the accompanying narrative discussions of best mode embodiments, do not purport to be completely rigorous treatments of the method, system, mobile device, and software product under consideration. A person skilled in the art will understand that the steps and signals of the present application represent general cause-and-effect relationships that do not exclude intermediate interactions of various types, and will further understand that the various steps and structures described in this application can be implemented by a variety of different sequences and configurations, using various different combinations of hardware and software which need not be further detailed herein.

What is claimed is:

1. A method for controlling web browsing costs incurred when using a device to access the world-wide web, comprising:
selecting a preferred browser strategy from a plurality of browser strategies that correspond to respective levels of estimated browsing costs; and
browsing at least one web page using the preferred browser strategy.

2. The method of claim 1, wherein the plurality of browser strategies comprises:
a luxury cost strategy for displaying entire web page contents;
an intermediate cost strategy for eliminating a plurality of types of content from a user display; and
an economy cost strategy for providing plain text, plus any images that may already exist in a cache of the device.

3. The method of claim 2, wherein the plurality of types of content comprise at least one of the following: advertising, images larger than an image size threshold, and flash animations.

4. The method of claim 2, wherein the plurality of browser strategies further comprises a custom browsing strategy that utilizes at least one cost threshold for at least one of the following: a browsing session, a browsed document, or a browsed image in a document.

5. The method of claim 1, wherein the preferred browser strategy is a default strategy chosen by a user of the device, with exceptions to the default strategy as instructed by the user.

6. The method of claim 1, further comprising:
memorizing the preferred browser strategy for the at least one web page; and
reapplying the preferred browser strategy when the at least one web page is again browsed.

7. The method of claim 1, wherein at least one of the plurality of browser strategies loads only images designated by source code of the web page as being important to load.

8. The method of claim 1, wherein the preferred browser strategy comprises analyzing at least one component of the at least one web page by requesting from a web server information about the at least one component before choosing whether to retrieve the at least one component.

9. The method of claim 8, wherein the information is used to estimate a cost of browsing the at least one component, and wherein the information is indicative of a size of the at least one component.

10. The method of claim 1, wherein the preferred browser strategy includes notifying a web server of the preferred browser strategy, and wherein the web server provides content conforming to the preferred browser strategy.

11. The method of claim 1, wherein the preferred browser strategy has different settings for at least two different telecommunications bearers, and wherein the settings include display of entire contents carried by one of the bearers if the entire contents is free.

12. The method of claim 11, wherein the settings are more economizing when the device senses a lower permissible data rate.

13. A computer readable medium encoded with a software data structure for controlling web browsing costs incurred when using a device to access the world-wide web, wherein a preferred browser strategy is initiated from a plurality of browser strategies that correspond to respective levels of estimated browsing costs, and wherein at least one web page is browsed using the preferred browser strategy.

14. The computer readable medium of claim 13, wherein the plurality of browser strategies comprises:
a luxury cost strategy for displaying entire web page contents;
an intermediate cost strategy for eliminating a plurality of types of content from a user display; and
an economy cost strategy for providing plain text, plus any images that may already exist in a cache of the device.

15. A device for controlling web browsing costs incurred by using the device to access the world-wide web, comprising:
a user interface for allowing a user to select a preferred browser strategy from a plurality of browser strategies that correspond to respective levels of estimated browsing costs, and for providing a preferred browser strategy signal; and
a browsing control module, responsive to the preferred browser strategy signal from the user interface, for ensuring that the device browses at least one web page using the preferred browser strategy.

16. The device of claim 15, wherein the plurality of browser strategies comprises:
a luxury cost strategy for displaying entire web page contents;
an intermediate cost strategy for eliminating a plurality of types of content from a user display; and
an economy cost strategy for providing plain text, plus any images that may already exist in a cache of the device.

17. A system for controlling web browsing costs incurred when using a device to access the world-wide web, comprising:
a device allowing a user to select a preferred browser strategy from a plurality of browser strategies that correspond to respective levels of estimated browsing costs, and for allowing the user to select at least one web page to browse using the preferred browser strategy; and
a station, for conveying the at least one web page selected by the user, from a telecommunications network.

18. The system of claim 17, wherein the plurality of browser strategies comprises:
a luxury cost strategy for displaying entire web page contents;
an intermediate cost strategy for eliminating a plurality of types of content from a user display; and
an economy cost strategy for providing plain text, plus any images that may already exist in a cache of the device.
